(19) United States
(12) Patent Application Publication
(10) Pub. No.: US 2003/0010159 A1
(43) Pub. Date: Jan. 16, 2003

(54) Biasing arrangement for a pawl of a reversible ratchet-type wrench

(76) Inventor: Bobby Hu, Taiehung (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/233,708

(22) Filed: Sep. 3, 2002

Related U.S. Application Data
(63) Continuation-in-part of application No. 09/942,061, filed on Aug. 29, 2001.
Application No. 09/942,061 is a continuation of application No. 09/541,193, filed on Apr. 3, 2000, now Pat. No. 6,282,992.

(51) Int. Cl. B25B 13/46

(52) U.S. Cl. 81/63.2

(57) ABSTRACT

A reversible ratchet-type wrench includes a handle and a head. A web is defined between the handle and the head and has a cavity and a compartment. A pawl is mounted in the cavity and includes teeth for releasably engaging with teeth of a drive member rotatably mounted in a hole of the head. A switch member includes an actuating member rotatably received in the compartment of the head. A pressing member and an elastic element are mounted between the pawl and the actuating member for biasing the teeth of the pawl to engage with the teeth of the drive member. The actuating member is substantially cylindrical and includes a receptacle extending along a diametrical direction. The actuating member further includes two chambered faces on both sides of the receptacle. The chamfered faces prevent operational interference between the pawl and the actuating member.

### CROSS REFERENCE TO RELATED APPLICATION

This is a continuation-in-part application of U.S. patent application Ser. No. 09/942,061 filed on Aug. 29, 2001, which is a continuation application of U.S. patent application Ser. No. 09/541,193 filed on Apr. 3, 2000, now U.S. Pat. No. 6,282,992.

### BACKGROUND OF THE INVENTION

1. Field of the Invention

The present invention relates to a biasing arrangement for a pawl of a reversible ratchet-type wrench to provide reliable ratcheting and reliable positioning of the switch member. The present invention also relates to an improved head structure for a ratchet-type wrench to lower the manufacture cost.

2. Description of the Related Art

FIG. 9 of the drawings illustrates a conventional reversible ratchet-type wrench comprising a handle 61 and a head 60. The head 60 includes a hole 63 for rotatably receiving a drive member 68. A web 65 is defined between the head 60 and the handle 61. A cavity 62 is defined in the web 17 for receiving a pawl 72 that has a plurality of teeth 74 in a side thereof for engaging with teeth 70 on an outer periphery of the drive member 68. Also defined in the web 65 is a compartment 64 that communicates with the cavity 62. A switch member 78 has a turn piece (see the dashed line) outside the web 65 for manual operation and an actuating member 80 that projects from the turn piece and that is rotatably received in the compartment 64. The actuating member 80 includes a receptacle 82 extending in a diametrical direction. A peg 84 includes a first end pressing against a recessed portion 76 in the other side of the pawl 72 and a second end received in the receptacle 82 of the actuating member 80. A receptacle 83 is defined in the second end of the peg 84. A spring 86 has two ends respectively attached to an end wall defining the receptacle 82 of the actuating member 80 and an end wall defining the receptacle 83 of the peg 84.

When in one of two retaining positions shown in FIG. 9, the peg 84 exerts a retaining force “d” to the pawl 72 under the action of the spring 86 to retain the pawl 72 in place. During free rotation of the wrench, forces imparted from the drive member 68 to the pawl 72 include a normal force “a” and a tangential force “b”, providing a resultant force “c”. The retaining force “d” must be greater than or equal to the resultant force “c” for retaining the pawl 72 and the actuating member 80 in place.

Since the actuating member 80 is substantially cylindrical, the actuating member 80 is located in a position away from the pawl 72 to prevent mutual interference between the pawl 72 and the actuating member 80. This adversely affects positioning of the switch member 78. More specifically, due to limitation of the mounting position of the actuating member 80, the longitudinal axis of the peg 84 is at an angle of at best 30° with the longitudinal axis of the handle 61. Thus, the resultant force “c” and the retaining force “d” have an angle θ therebetween. As a result, the retaining force “d” could not counterbalance the resultant force “c”, as the component force of the retaining force “d” in the direction of the resultant force “c” is smaller than the magnitude of the resultant force “c”.

A solution to this problem is to provide another receptacle 66 in a periphery defining the compartment 64, and a spring 69 and a ball 67 are mounted in the receptacle 66. The ball 67 is biased by the spring 69 to be retained in one of two positioning grooves 85 in the actuating member 80. The provision of the additional biasing means consists of a ball 67 and a spring 69 provides an additional retaining force to retain the actuating member 80 and the pawl 72 in place during free rotation of the wrench. However, processing of the receptacle 66 is difficult and incurs additional cost. Formation of the positioning grooves 85 in the actuating member 80 complicates manufacture of the wrench and also incurs additional cost. Further, the spring 69 and the ball 67 make the assembly procedure more complicated.

### SUMMARY OF THE INVENTION

It is an object of the present invention to provide a reversible ratchet-type wrench providing reliable positioning of the switch member without the need of additional biasing means. Thus, the reversible ratchet-type wrench has a simplified structure and is thus easy to manufacture and assemble.

In accordance with a first aspect of the invention, a reversible ratchet-type wrench comprises:

a handle;

a head extending from the handle and including a hole, a web being defined between the handle and the head, a cavity being defined in the web and communicated with the hole, the web further including a compartment communicated with the cavity;

a drive member rotatably mounted in the hole of the head, the drive member including a plurality of teeth formed on an outer periphery thereof;

a pawl mounted in the cavity and including a first side with a plurality of teeth for releasably engaging with the teeth of the drive member and a second side having a recessed portion;

a switch member including a turn-piece for manual operation and an actuating plate extended from the turn-piece and rotatably received in the compartment of the web, the switch member being switchable between two positions for changing ratcheting direction of the wrench, the actuating member being substantially cylindrical and including a receptacle extending along a diametrical direction, the actuating member further including two chamfered faces on both sides of the receptacle, the chamfered faces preventing operational interference between the pawl and the actuating member; and

a pressing member and an elastic element mounted between the pawl and the actuating member for biasing the teeth of the pawl to engage with the teeth of the drive member.

The pressing member includes an end pressing against the recessed portion of the pawl. The pressing member includes a receptacle in the other end thereof. The elastic element is attached between an end wall defining the receptacle of the actuating member and an end wall defining the receptacle of the pressing member. The recessed portion of the pawl includes two ends to which the end of the pressing member selectively presses against. A longitudinal axis of the pressing member is at an angle of 35°-50° with a longitudinal axis of the handle when the end of the pressing member presses against one of the two ends of the recessed portion of the pawl. The pawl and the actuating member can be reliably retained in place without the use of additional biasing means required in conventional designs.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an end portion of a first embodiment of a ratchet-type wrench in accordance with the present invention.

FIG. 2 is an exploded perspective view of the end portion of the ratchet-type wrench in FIG. 1.

FIG. 3 is a sectional view of the end portion of the ratchet-type wrench in FIG. 1, wherein an actuating member of a switch member is in a position allowing ratcheting in a direction.

FIG. 4 is a sectional view similar to FIG. 3, wherein the actuating member is in a transition position.

FIG. 5 is a sectional view similar to FIG. 3, wherein the actuating member is in a position allowing ratcheting in a reverse direction.

FIG. 6 is a sectional view similar to FIG. 3, illustrating retaining of the pawl and the actuating member during free rotation of the wrench.

FIG. 7 is a perspective view illustrating a second embodiment of the ratchet-type reversible wrench in accordance with the present invention.

FIG. 8 is a sectional view of the ratchet-type reversible wrench in FIG. 7.

FIG. 9 is a sectional view of a conventional ratchet-type reversible wrench.

### DETAILED DESCRIPTION OF THE PREFERRED EMBODIMENTS

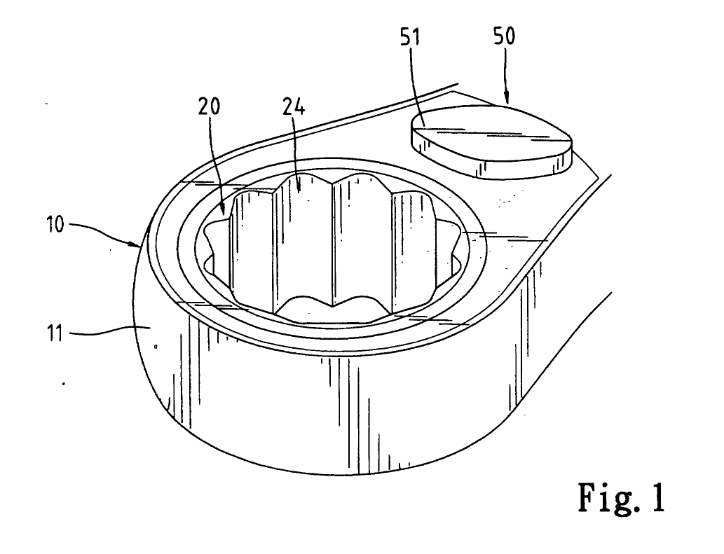

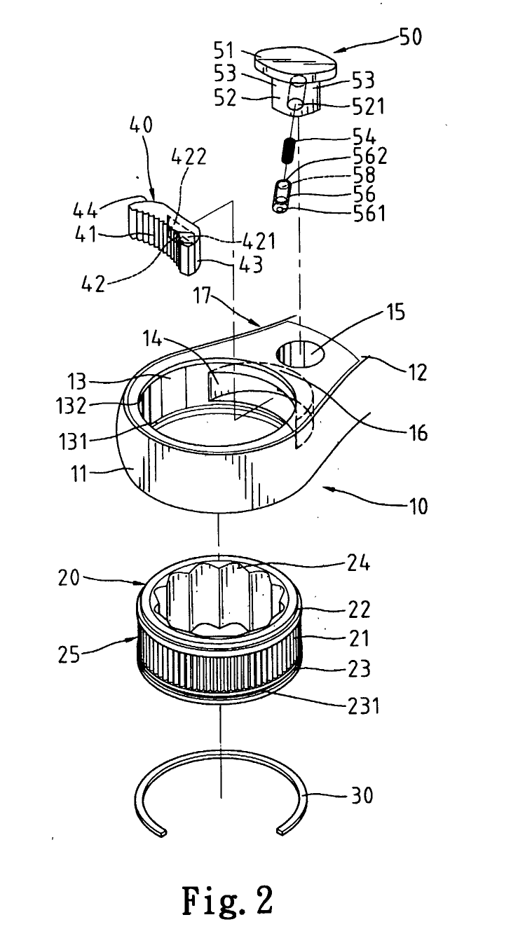

Referring to FIGS. 1 through 3, a first embodiment of a ratchet-type reversible wrench 10 in accordance with the present invention generally includes a handle 12 and a head 11 extending from the handle 12 and having a hole 13. An inner periphery 132 defining the hole 13 of the head 11 includes an annular groove 131 in a lower portion thereof. A web 17 is defined between the head 11 and the handle 12. A cavity 14 is defined in the web 17. Also defined in the web 17 is a compartment 15 that is substantially L-shaped and includes an inner end communicated with the cavity 14 and an outer end communicated with outside, thereby leaving a bridge 16 on the web 17. The outer end of the compartment 15 is preferably circular. The bridge 16 increases the strength of the head 11 and the handle 12, thereby providing a higher torque-bearing capacity.

A drive member (in the form of a gear wheel 20 in this embodiment) is mounted in the head 11 and includes an inner periphery 24 for driving a fastener (not shown) and an outer periphery 25. The outer periphery 25 includes a recessed upper end portion 22, a lower end portion 23, and a middle portion with a plurality of teeth 21. The lower end portion 23 includes an annular groove 231. A C-clip 30 is received in the annular groove 231 of the lower end portion 23 and the annular groove 131 of the head 11, thereby rotatably retaining the gear wheel 20 in the head 11 of the wrench 10.

A pawl 40 is mounted in the cavity 14 in the web 17 and includes ratchet teeth 41 on a side thereof for engaging with the teeth 21 of the gear wheel 20. The other side of the pawl 40 further includes a recessed portion 42 having two ends 421 and 422, which will be described later.

Still referring to FIGS. 1 through 3, a switch member 50 is rotatably mounted in a vertical section of the compartment 15. In this embodiment, the switch member 50 includes a turn-piece 51 outside the compartment 15 for manual operation and an actuating member 52 extending from the turn-piece 51 and having a receptacle 521 that faces the cavity 14. An elastic element 54 and a pressing member 56 are attached between the actuating member 52 and the recessed portion 42 of the pawl 40. In this embodiment, the actuating member 52 includes a receptacle 521 extending in a diametrical portion and two chamfered faces 53 on both sides of the receptacle 521. The chamfered faces 53 are at an acute angle with each other. More specifically, the actuating member 52 is substantially cylindrical, and a receptacle 521 is defined in the actuating member 52 and extends in a diametrical portion. Then, the cylindrical actuating member 52 is chamfered on both sides of the receptacle 521, leaving two chamfered faces 53 on both sides of the receptacle 521. Of course, the actuating member 52 can be constructed in other ways to provide a receptacle 521 and two chamfered or beveled faces 53 on both sides of the receptacle. For example, the switch member 50 can be integrally formed by means of molding injection. The pressing member 56 includes a first end 561 pressing against the recessed portion 42 of the pawl 40 and a second end 562 having a receptacle 58 defined therein. The second end 562 of the pressing member 56 is received in the receptacle 521 of the actuating member 52. The elastic element 54 is attached between an end wall defining the receptacle 521 of the actuating member 52 and an end wall defining the receptacle 58 of the pressing member 56.

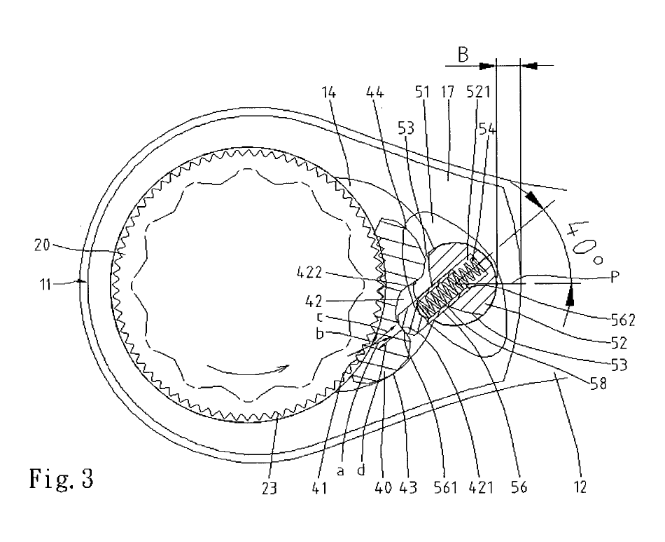

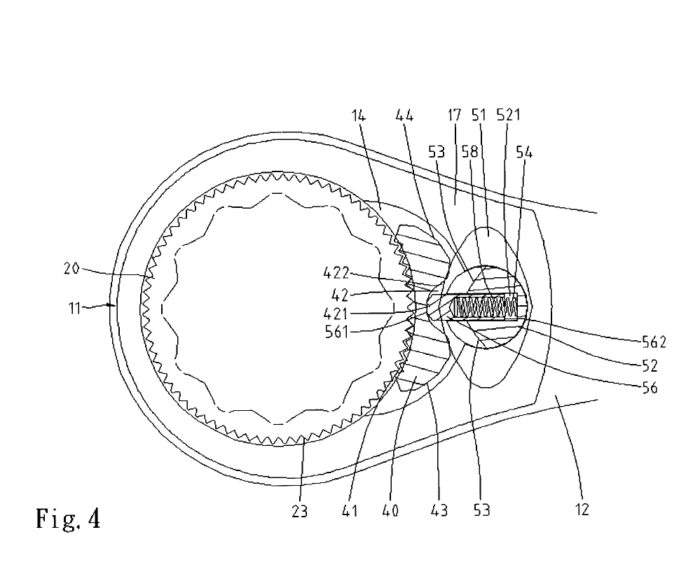

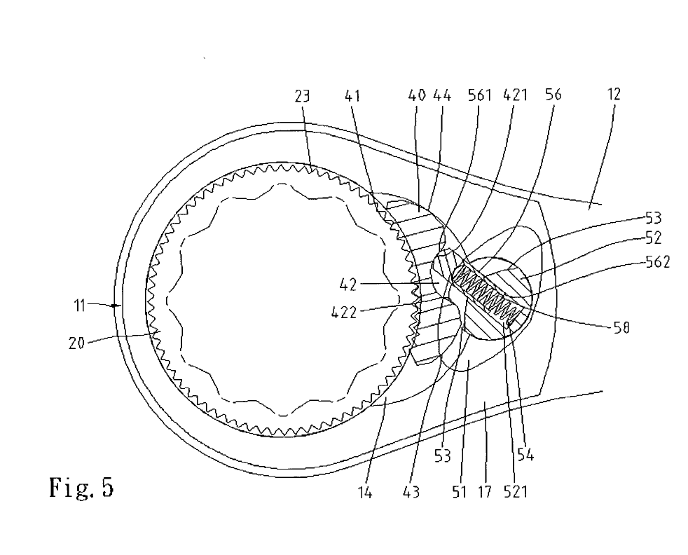

The ratchet-type wrench in FIG. 3 is in a status allowing clockwise ratcheting (free rotation in counterclockwise direction), in which the first end 561 of the pressing member 56 bears against an end 421 of the recessed portion 42 of the pawl 40, and an end face 43 of the pawl 40 bears against a wall portion defining the cavity 14. When a change in the ratcheting direction is required, the user may switch the turn-piece 51 and thus cause the pressing member 56 to move. FIG. 4 shows a transition position for the ratchet-type wrench that allows free rotation in both directions. When the turn-piece 51 reaches its predetermined position shown in FIG. 5, the first end 561 of the pressing member 56 bears against the other end 422 of the recessed portion 42 of the pawl 40, and the other end face 44 of the pawl 40 bears against another wall portion defining the cavity 14. Thus, the ratchet-type wrench is in a status allowing counterclockwise ratcheting and free rotation in the clockwise direction.

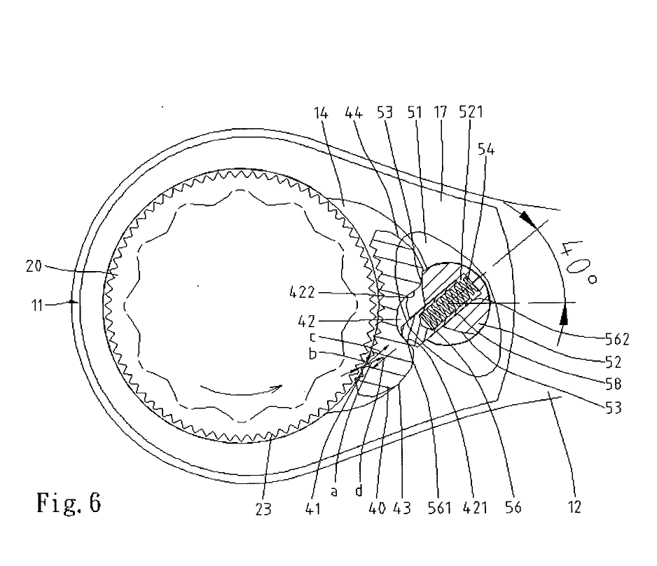

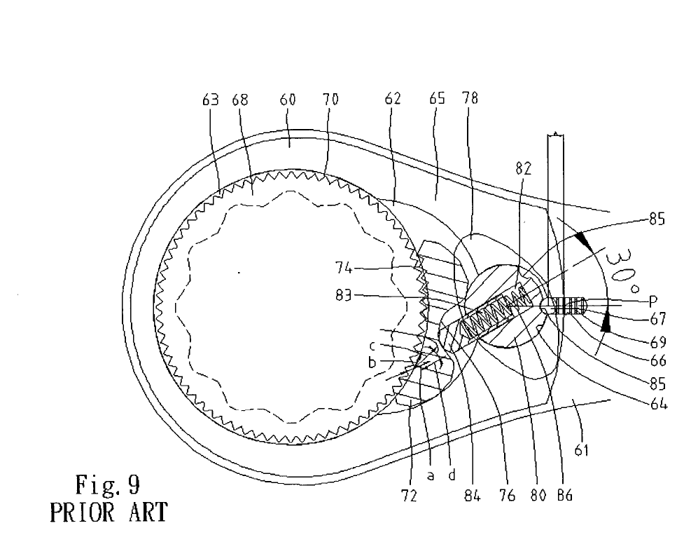

It is noted that the chamfered faces 53 of the actuating member 53 allows it to be located in a position closer to the pawl 40 without interfering operation of the pawl 40 and the actuating member 52 (compare the distance B between the actuating member 52 and a reference point P in FIG. 3 with the distance A between the actuating member 80 and the reference pint P in FIG. 9). Thus, when the pawl 40 is in one of two retaining positions, e.g., the retaining position shown in FIG. 6, the longitudinal axis of the pressing member 56 is at a larger angle with a longitudinal axis of the handle 12. The angle is between 35°-50° (40° in this embodiment). During free rotation of the wrench, forces imparted from the gear wheel 20 to the pawl 40 include a normal force “a” and a tangential force “b”, providing a resultant force “c”. Since the angle between the longitudinal axis of the pressing member 56 and the longitudinal axis of the handle 12 is sufficiently large, the resultant force “c” and the retaining force “d” have no angle therebetween. Namely, the resulting force “d” is opposite to the resultant force “c”. As a result, the retaining force “d” could counterbalance the resultant force “c”; i.e., the retaining force “d” is greater than or equal to resultant force “c”. Accordingly, the actuating member 52 and the pawl 40 would not be moved during the free rotation of the handle 12. Namely, the ratcheting direction of the wrench remains the same.

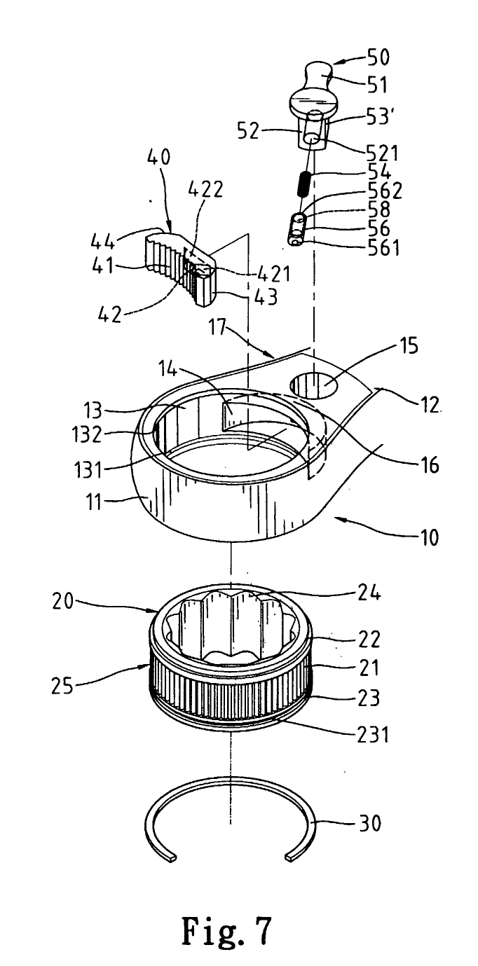

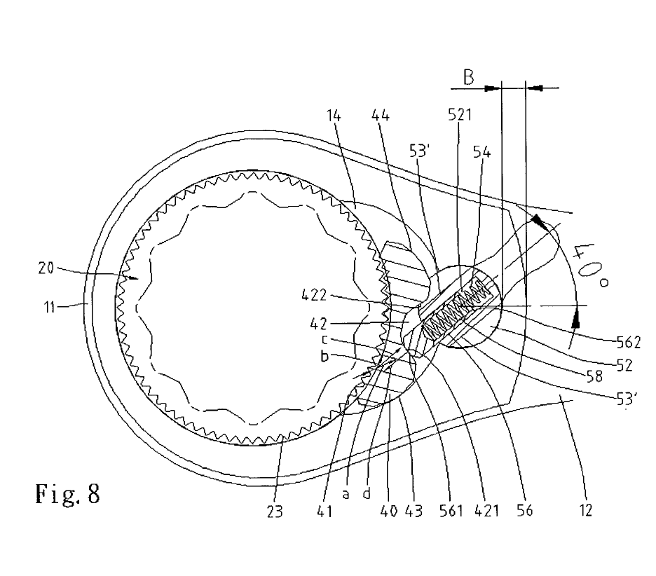

FIGS. 7 and 8 illustrate a second embodiment in accordance with the present invention, wherein the chamfered faces (now designated by 53′) of the actuating member 52 are different from those in the first embodiment. In this embodiment, the chamfered faces 53′ are parallel to each other. It is noted that the chamfered faces of the actuating member 52 can be optionally configured as long as they would not interfere with operation of the pawl 40.

The pawl 40 and the switch member 50 are retained in place by the pressing member 56 and the elastic element 54. It is appreciated that the pressing member 56 and the elastic element 54 can be of any other shapes and forms.

According to the above description, it is appreciated that the ratchet-type reversible wrench in accordance with the present invention has a simplified structure and has fewer elements without affecting the positioning effect for the pawl 40 and the actuating member 52 (i.e., the switch member 50). Namely, the pawl 40 and the actuating member 52 can be reliably retained in place without the use of additional biasing means required in conventional designs. Manufacture and assembly of the ratchet-type reversible wrench in accordance with the present invention are easy, and the cost therefor is accordingly reduced.

Although the invention has been explained in relation to its preferred embodiments, it is to be understood that many other possible modifications and variations can be made without departing from the spirit and scope of the invention as hereinafter claimed.

What is claimed is:

1. A reversible ratchet-type wrench comprising:
a handle;
a head extending from the handle and including a hole, a web being defined between the handle and the head, a cavity being defined in the web and communicated with the hole, the web further including a compartment communicated with the cavity;
a drive member rotatably mounted in the hole of the head, the drive member including a plurality of teeth formed on an outer periphery thereof;
a pawl mounted in the cavity and including a first side with a plurality of teeth for releasably engaging with the teeth of the drive member and a second side having a recessed portion;
a switch member including a turn-piece for manual operation and an actuating plate extended from the turn-piece and rotatably received in the compartment of the web, the switch member being switchable between two positions for changing ratcheting direction of the wrench, the actuating member being substantially cylindrical and including a receptacle extending along a diametrical direction, the actuating member further including two chamfered faces on both sides of the receptacle, the chamfered faces preventing operational interference between the pawl and the actuating member; and
a pressing member and an elastic element mounted between the pawl and the actuating member for biasing the teeth of the pawl to engage with the teeth of the drive member.

2. The reversible ratchet-type wrench as claimed in claim 1, wherein the pressing member includes an end pressing against the recessed portion of the pawl, the pressing member including a receptacle in another end thereof, the elastic element being attached between an end wall defining the receptacle of the actuating member and an end wall defining the receptacle of the pressing member.

3. The reversible ratchet-type wrench as claimed in claim 1, wherein the recessed portion of the pawl includes two ends to which the end of the pressing member selectively presses against.

4. The reversible ratchet-type wrench as claimed in claim 3, wherein a longitudinal axis of the pressing member is at an angle of 35°-50° with a longitudinal axis of the handle when the end of the pressing member presses against one of the two ends of the recessed portion of the pawl.

5. The reversible ratchet-type wrench as claimed in claim 1, wherein the chamfered faces are at an acute angle with each other.

6. The reversible ratchet-type wrench as claimed in claim 1, wherein the chamfered faces are parallel to each other.
